(19) United States
(12) Patent Application Publication
(10) Pub. No.: US 2023/0224381 A1
(43) Pub. Date: Jul. 13, 2023

(54) COMPUTING DEVICE

(71) Applicant: ELECTRONICS AND TELECOMMUNICATIONS RESEARCH INSTITUTE, Daejeon (KR)

(72) Inventor: Byung-Kwon JUNG, Daejeon (KR)

(73) Assignee: ELECTRONICS AND TELECOMMUNICATIONS RESEARCH INSTITUTE, Daejeon (KR)

(21) Appl. No.: 18/174,254

(22) Filed: Feb. 24, 2023

(30) Foreign Application Priority Data
Jan. 7, 2022 (KR) 10-2022-0002550

(51) Int. Cl. H04L 69/16; G06F 13/40

(52) U.S. Cl. CPC H04L 69/16; G06F 13/4063

(57) ABSTRACT

Disclosed herein is a computing device. The computing device may include a central processing unit (CPU) for controlling operation of a system, a Compute Express Link (CXL) storage device connected with the CPU, a flexible bus for connecting the CPU with the CXL storage device, and a TCP/IP Offload Engine (TOE) provided between the flexible bus and the CXL storage device.

### CROSS REFERENCE TO RELATED APPLICATION

This application claims the benefit of Korean Patent Application No. 10-2022-0002550, filed Jan. 7, 2022, which is hereby incorporated by reference in its entirety into this application.

### BACKGROUND OF THE INVENTION

### 1. Technical Field

The present disclosure relates generally to a computing device, and more particularly to a computing device capable of being applied to a high-performance server of a system.

### 2. Description of the Related Art

These days, a high-performance computing system is required for processing of big data in the fields of Artificial Intelligence (AI), image classification, voice recognition, medical diagnosis, autonomous driving, and the like. Accordingly, not only handling of multimedia big-data such as images, video, audio, and the like, which are easily accessed and used, but also collection, storage, processing, and analysis of big data in the fields of search engines, finance, and communication are required.

To this end, faster data-processing, larger amounts of memory, and a more efficient memory access method are required in a computing system.

A conventional computing system performs data-processing using a Peripheral Component Interconnect Express (PCIe) protocol, but there are problems such as low bandwidth, high latency, memory sharing between I/O and a CPU, and consistency.

Also, as applications such as a big-data program, a machine-learning application, and the like have become popular, the conventional computing system lacks memory and has a problem in that it is difficult to quickly execute a program using only the existing memory.

### SUMMARY OF THE INVENTION

An object of the present disclosure is to provide a high-performance computing device that is capable of solving the problems of a lack of memory and a processing delay when an application consuming lots of memory resources is executed.

In order to accomplish the above object, a computing device according to the present disclosure may include a central processing unit (CPU) for controlling operation of a system, a Compute Express Link (CXL) storage device connected with the CPU, a flexible bus for connecting the CPU with the CXL storage device, and a TCP/IP offload engine (TOE) provided between the flexible bus and the CXL storage device.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating the entire structure of a computing device according to an embodiment of the present disclosure;

FIG. 2 is a block diagram illustrating the structure of a physical interface provided in a CPU;

FIG. 3 is a block diagram illustrating a connection structure of a card connected with a PCIe slot;

FIG. 4 is a flowchart illustrating a data-processing process when a packet is received according to an embodiment; and

FIG. 5 is a flowchart illustrating a data-processing process when a packet is received according to another embodiment.

### DESCRIPTION OF THE PREFERRED EMBODIMENTS

The advantages and features of the present disclosure and methods of achieving the same will be apparent from the exemplary embodiments to be described below in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only, and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

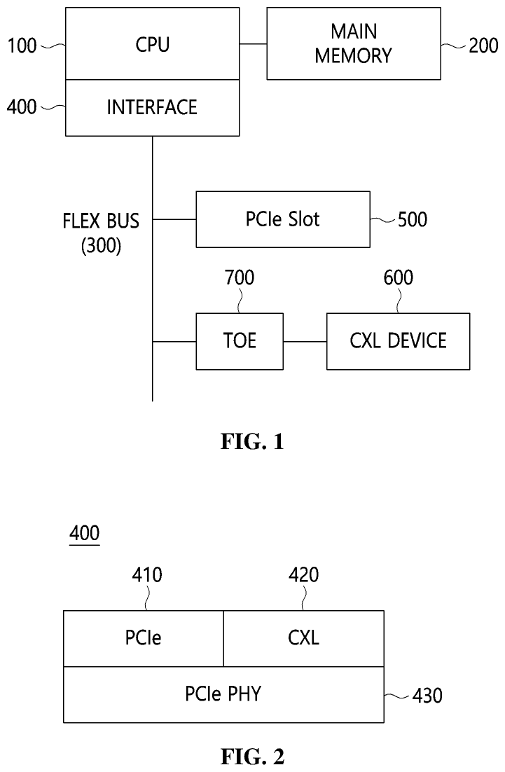

FIG. 1 is a block diagram illustrating the entire structure of a computing device according to an embodiment of the present disclosure.

Referring to FIG. 1, a computing device according to an embodiment may include a Central Processing Unit (CPU) 100, main memory 200, a standard PCIe slot 500 and a CXL storage device 600, which are internal components connected with the CPU 100, a flexible bus (flex bus) 300 for selectively connecting the standard PCIe slot 500 with the CXL storage device 600, and a TOE 700 provided between the flexible bus 300 and the CXL storage device 600.

The CPU 100 may be a processor for overall control of the computing device.

The main memory 200 is volatile memory, and may function to temporarily store a page table or data for a process processed by the CPU 100. That is, the main memory 200 is initialized when the CPU 100 starts a boot process using a bootloader, and when the CPU 100 creates a process by loading a program stored in a hard disk in order to execute the program, the main memory 200 may be used for loading a page table for the process.

The flexible bus 300 may be a flexible high-speed port that can select a PCIe protocol or the CXL storage device through a high-bandwidth, off-package link. That is, the flexible bus may serve as a switch.

Conventional technology uses a PCI bus, but the embodiment uses the flexible bus 300, thereby enabling a CXL environment to be designed. At the opposite ends of the flexible bus 300, a physical interface 400 may be configured.

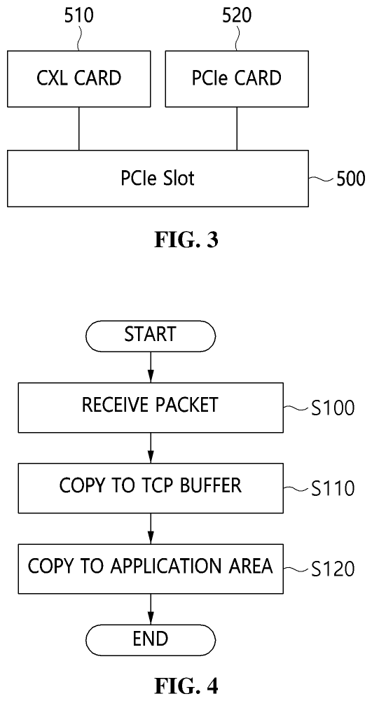

FIG. 2 is a block diagram illustrating the structure of a physical interface provided in a CPU.

As illustrated in FIG. 2, the physical interface 400 serves to connect to the CPU 100 depending on a protocol structure. The physical interface 400 may include PCIe 410, a CXL 420, and PCIe PHY 430, but the type of the physical interface 400 is not limited thereto.

Referring back to FIG. 1, the CXL storage device 600 may include high-bandwidth memory (HBM), a memory pool, a field-programmable gate array (FPGA), I/O, and the like. The CXL storage device 600 may include multiple protocols multiplexed onto a single link. The multiple protocols may include CXL.io, CXL.cache, and CXL.memory.

The CXL.io protocol is a PCIe transaction layer, and may be used for a device search, interrupt management, provision of access to a register, initialization processing, and signal-error-handling in the system. The CXL.cache protocol may be used when an accelerator accesses the main memory of the CPU. The CXL.memory protocol may be used when the CPU 100 accesses the memory of the accelerator.

FIG. 3 is a block diagram illustrating a connection structure of a card connected with a PCIe slot.

As illustrated in FIG. 3, at least one card may be mounted in the PCIe slot 500, and the type of card may include a CXL card 510 and a PCIe card 520.

The computing device according to an embodiment additionally builds a storage device using a CXL interface on the system main board and uses the same, whereby large amounts of data generated at the runtime of a program may be effectively processed.

Referring back to FIG. 1, the computing device according to an embodiment may solve a network delay problem by using the TCP/IP Offload Engine (TOE) 700 and a zero-copy function. That is, the TOE 700 and the zero-copy function enable large amounts of data transmitted and received over a network to be processed without intervention of the CPU 100, thereby solving the network delay problem.

The TOE 700 is a TCP/IP acceleration device for processing a TCP/IP protocol (e.g., calculation of checksums at TCP and IP layers) in place of a CPU, and is a hardware protocol stack that is separate from a system by implementing a TCP/IP protocol stack, which used to be processed by software, as separate dedicated hardware.

The TOE 700 may be implemented using an FPGA, an application-specific integrated circuit (ASIC), or other dedicated chipsets.

Generally, when data is transmitted and received, the data has to be copied to the CXL storage device 600. In order to transmit data via the CXL storage device 600, the data is first copied from an application user area to an operating system (OS) kernel area, after which the data is copied from the kernel area to the packet buffer of the CXL storage device 600.

Also, in order to receive data via the CXL storage device 600, a packet received by the CXL storage device 600 is first stored in the packet buffer (not illustrated) of the CXL storage device 600, the data is copied to a TCP buffer, and then the data is finally copied to the application area, whereby data-copying is performed a total of three times.

However, the use of the TOE 700 and a zero-copy algorithm according to an embodiment may reduce such a data-processing process.

FIG. 4 is a flowchart illustrating a data-processing process when a packet is received according to an embodiment.

As illustrated in FIG. 4, when a TOE 700 is used, a packet received by a CXL storage device 600 at step S100 may be copied to a TCP buffer at step S110. Then, the packet may be finally copied to an application area at step S120.

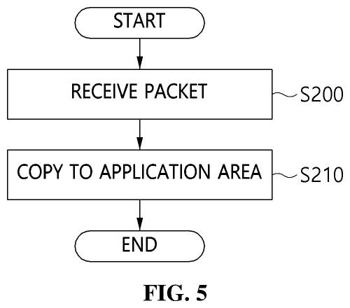

FIG. 5 is a flowchart illustrating a data-processing process when a packet is received according to another embodiment.

As illustrated in FIG. 5, when a TOE 700 and a zero-copy algorithm are used, a packet received by a CXL storage device 600 at step S200 may be copied to an application area at once by the zero-copy algorithm at step S210.

Here, the zero-copy technique is a method by which data in the CXL storage device 600 is capable of being transmitted via the TOE 700 through the CXL.io protocol of the CXL storage device 600 without intervention of the CPU 100.

Accordingly, the computing device according to an embodiment has the effect of more improving the data-processing efficiency.

The present disclosure has the effects of improving the operation speed of an entire system and reducing the operation time thereof by standardizing and unifying the interface of a computing system to a CXL interface standard.

Also, the present disclosure has the effect of more improving data-processing efficiency by adding a TOE between a flexible bus and a CXL storage device.

Also, the present disclosure has the effect of enabling a high-precision operation even when bypassing a CPU.

As described above, the computing device according to the present disclosure is not limitedly applied to the configurations and operations of the above-described embodiments, but all or some of the embodiments may be selectively combined and configured, so the embodiments may be modified in various ways.

What is claimed is:

1. A computing device, comprising:
a central processing unit (CPU) for controlling operation of a system;
a Compute Express Link (CXL) storage device connected with the CPU;
a flexible bus for connecting the CPU with the CXL storage device; and
a TCP/IP Offload Engine (TOE) provided between the flexible bus and the CXL storage device.
